(19) United States
(12) Patent Application Publication
(10) Pub. No.: US 2018/0097322 A1
(43) Pub. Date: Apr. 5, 2018

(54) FLEXIBLE BUS BAR

(71) Applicant: Faraday&Future Inc., Gardena, CA (US)

(72) Inventor: John Henry Harris, III, San Gabriel, CA (US)

(21) Appl. No.: 15/282,091

(22) Filed: Sep. 30, 2016

(51) Int. Cl. H01R 25/16; H02G 5/02; H01M 2/20

(52) U.S. Cl. CPC H01R 25/162; H01M 2220/20; H01M 2/206; H02G 5/02

(57) ABSTRACT

Systems and methods for forming flexible electrical connections are disclosed. Systems can include a flexible bus bar having at least three rigid sections and at least two flexible sections. Each flexible section can be mechanically and conductively coupled to two of the at least three rigid sections. Each rigid section can be configured to electrically couple to an electrical component other than the bus bar. The flexible bus bar can be configured to electrically connect a plurality of batteries in a vehicle battery system. The flexible sections of the flexible bus bar can flex to accommodate thermal expansion and/or contraction of the bus bar or relative movement of other electrical components.

### TECHNICAL FIELD

The present disclosure is related to for electrical connections capable of carrying large currents across relatively long distances. More particularly, a bus bar configured to flexibly connect a plurality of electrical components is disclosed herein.

### BACKGROUND

Bus bars may be used to form current-carrying electrical connections between electrical components. Bus bars may be able to carry larger currents than thin current carrying wires.

### SUMMARY

The devices, systems, and methods disclosed herein have several features, no single one of which is solely responsible for its desirable attributes. Without limiting the scope as expressed by the claims that follow, its more prominent features will now be discussed briefly. After considering this discussion, and particularly after reading the section entitled “Detailed Description of the Preferred Embodiments” one will understand how the features of the system and methods provide several advantages over traditional systems and methods.

In one embodiment, a flexible bus bar is described. The flexible bus bar includes at least three rigid bus bar sections and at least two flexible bus bar sections, each flexible bus bar section being mechanically and conductively coupled to two of the at least three rigid bus bar sections. Each section of the at least three rigid bus bar sections can be configured to electrically couple to an electrical component other than the bus bar. Each section of the at least three rigid bus bar sections can include an aperture configured to electrically couple to a terminal post of a battery module. The at least three rigid bus bar sections can include one of aluminum, copper, an aluminum alloy, and a copper alloy. The at least two flexible bus bar sections can include one of aluminum, copper, an aluminum alloy, and a copper alloy. The at least three rigid bus bar sections can include a first metallic material, and the at least two flexible bus bar sections can include a second metallic material different from the first metallic material. At least a portion of the exterior surface of the bus bar can be coated with an electrically insulating material. The electrically insulating material can include a powder coating. The electrically insulating material can include a tubing at least partially surrounding at least one of the at least two flexible bus bar sections.

In another embodiment, a battery system is described. The battery system includes at least three battery modules and a flexible bus bar. Each battery module includes a positive terminal post. The flexible bus bar includes at least three rigid bus bar sections and at least two flexible bus bar sections conductively coupling the at least three rigid bus bar sections. Each of the at least three rigid bus bar sections is conductively coupled to the positive terminal post of a module of the at least three battery modules. At least one of the rigid bus bar sections can be configured to electrically connect the flexible bus bar to an electrically powered system configured to draw power from the battery system. The at least three battery modules can include at least a portion of a low-voltage battery system of a vehicle. The at least three battery modules can include at least a portion of a high-voltage battery system of a vehicle.

In another embodiment, a method of manufacturing a flexible bus bar is described. The method includes obtaining at least three rigid metallic bus bar sections, obtaining at least two flexible metallic bus bar sections, and conductively securing each of the at least two flexible metallic bus bar sections to two of the at least three rigid metallic bus bar sections. The at least three rigid metallic bus bar sections can include one of aluminum, copper, an aluminum alloy, and a copper alloy. The at least two flexible metallic bus bar sections can include one of aluminum, copper, an aluminum alloy, and a copper alloy. The conductively securing can include at least one of welding, soldering, brazing, bolting, and riveting. The method can further include covering at least a portion of the bus bar with an electrically insulating material. The electrically insulating material can include a powder coating. The electrically insulating material can include a tubing at least partially surrounding at least one of the flexible metallic bus bar sections.

In another embodiment, a flexible bus bar includes two electrically conductive bus bars coupled together with an electrically conductive joint, the conductive bus bars each configured to be coupled to at least one electrical connection, the conductive joint configured to allow the two bus bars to move relative to one another. The electrical connection can include a terminal post of a battery module. At least a portion of the exterior surface of the bus bars can be covered by an electrically insulating material. The electrically insulating material can include an insulating powder coating. At least a portion of the exterior surface of the conductive joint can be covered by an electrically insulating material. The electrically insulating material covering the conductive joint can include a rubber wrap. The two electrically conductive bus bars and the electrically conductive joint can extend in one linear direction. The flexible bus bar can further include an additional conductive joint coupling one of the two bus bars to an additional bus bar, the additional bus bar configured to be coupled to at least one electrical connection, and the additional conductive joint configured to allow the three bus bars to move with respect to one another.

In another embodiment, a flexible bus bar includes two electrically conductive bus bars coupled together with an electrically conductive joint, the two conductive bus bars each configured to be coupled to at least one electrical connection, the conductive joint having a thermal linear expansion coefficient that is different than the thermal linear expansion coefficient of the bus bars. The conductive joint can have a thermal linear expansion coefficient that is less than the thermal linear expansion coefficient of the bus bars. The conductive joint can have a thermal linear expansion coefficient that is greater than the thermal linear expansion coefficient of the bus bars. The flexible bus bar can further include an additional conductive joint coupling one of the two bus bars to an additional bus bar, the additional bus bar configured to be coupled to at least one electrical connection, the additional conductive joint having the same thermal linear expansion coefficient as the conductive joint and the additional bus bar having the same thermal linear expansion coefficient as the two bus bars.

In another embodiment, a flexible bus bar includes two electrically conductive bus bars coupled together with an electrically conductive joint, the two conductive bus bars each configured to be coupled to at least one electrical connection, the conductive joint configured to be more flexible when compared to the bus bars. The electrical connection can include a terminal post of a battery module. At least a portion of the exterior surface of the bus bars can be covered by an electrically insulating material. The electrically insulating material can include an insulating powder coating. At least a portion of the exterior surface of the conductive joint can be covered by an electrically insulating material. The electrically insulating material covering the conductive joint can include a rubber wrap. The two electrically conductive bus bars and the electrically conductive joint can extend in one linear direction. The flexible bus bar can further include an additional conductive joint coupling one of the two bus bars to an additional bus bar, the additional bus bar configured to be coupled to at least one electrical connection, and the additional conductive joint configured to be more flexible when compared to the bus bars.

### BRIEF DESCRIPTION OF THE DRAWINGS

The following is a brief description of each of the drawings. From figure to figure, the same reference numerals have been used to designate the same components of an illustrated embodiment. The drawings disclose illustrative embodiments and particularly illustrative implementations in the context of connecting a plurality of electrochemical cells. They do not set forth all embodiments. Other embodiments may be used in addition to or instead. Conversely, some embodiments may be practiced without all of the details that are disclosed. It is to be noted that the Figures may not be drawn to any particular proportion or scale.

FIG. 1A is an upper perspective view of a segmented flexible bus bar in accordance with an exemplary embodiment.

FIG. 1B is a lower perspective view of the segmented flexible bus bar of FIG. 1A.

FIG. 1C is a top view of the segmented flexible bus bar of FIGS. 1A and 1B.

FIG. 1D is a side view of the segmented flexible bus bar of FIGS. 1A-1C.

FIG. 2 depicts a plurality of battery modules electrically connected by a segmented flexible bus bar consistent with the bus bar depicted in FIGS. 1A-1D.

FIG. 3 is a flowchart depicting an exemplary method of manufacturing a segmented flexible bus bar.

### DETAILED DESCRIPTION OF THE PREFERRED EMBODIMENTS

In electrical vehicles it may be necessary to conduct relatively large currents across relatively long distances for relatively long periods of time. For example, in some aspects, bus bars may need to be several feet in length and conduct in the range of 300 Amps for at least fifteen minutes at a time, or longer. In some aspects, a plurality of battery packs may be connected in series and/or in parallel. A connection with a traditional bus bar may be compromised by the relative motion of components connected to the bus bur. Bus bars may experience significant thermal expansion and/or contraction due to resistive heating when a current through the bus bar is increased, decreased, initiated, or discontinued. While larger bus bars may expand less than smaller bus bars, larger bus bars may add weight, cost, and size.

Disclosed herein is a segmented bus bar. In some aspects, the bus bar comprises two bus bars that are coupled together by a conductive section that is either more flexible, or more pliable, when compared to the two bus bars. In this way, the two bus bars may move relative to one another.

The conductive section in between the two bus bars may be configured to expand and or contract to a greater extent that the two bus bars. Thus, the conductive section may shrink and or expand during temperature fluctuations to a greater extent than the bus bars. Accordingly, the conductive section middle section may provide a means for preventing the overall length of the combined bus bars and middle section from expanding and/or contracting. Additionally, the implementation of a conductive section that can shrink or expand to accommodate the effects of thermal expansion and contraction may permit an otherwise “undersized” bus bar to be utilized to carry a higher current than traditional thermal models of that bus bar material would allow. Thus, such a conductive section may be used to save space or weight. Further, where the bus bar is terminated next to delicate components, even a small temperature rise over a short length of bus bar could result in an unacceptably large thermal expansion of the bus bar. It is thus desirable to configure the conductive section such that it can change shape to mitigate the negative effects of thermal fluctuations on the shape of the bus bar.

In some aspects, the conductive section middle section may function as a joint that links at least two bus bars together. The joint or joint-like section may allow for a longer length bus bar. The joint or joint-like section may allow for the two bus bars, which are coupled to the joint or joint-like section, to move relative to one another. This additional degree of freedom may help the bus bars remain in contact with the electrical connections during thermal expansion/contraction and/or during vibrations encountered while driving.

In some implementations, a bus bar has at least three rigid portions and at least two flexible portions. Such flexible bus bars may be particularly suited to connect electrical components in applications where the connected components can move, or in high-current applications in which thermal expansion and/or contraction are likely to occur in the bus bar. However, a flexible bus bar material may be less desirable than a rigid bus bar material for forming a robust electrical connection with adjacent components. Accordingly, a segmented bus bar having a plurality of rigid sections connected by flexible segments may allow for flexible bus bar functionality to be implemented with a linear array of three or more electrical components. The segmented flexible bus bars described herein may be able to accommodate more thermal expansion than rigid or non-segmented flexible designs, and may thus allow the use of a smaller bus bar with a higher allowable temperature variation in high-current applications. Additional rigid sections may be added by coupling them together with additional flexible sections. In general, the bus bars disclosed herein include an alternating pattern of rigid and flexible sections.

The following description is directed to certain implementations for the purpose of describing the innovative aspects of this disclosure. However, a person having ordinary skill in the art will readily recognize that the teachings herein can be applied in a multitude of different ways.

As used herein, the term “electric vehicle” can refer to any vehicle that is partly or entirely operated based on stored electric power, such as a pure electric vehicle, plug-in hybrid electric vehicle, or the like. Such vehicles can include, for example, road vehicles (cars, trucks, motorcycles, buses, etc.), rail vehicles, wheeled robots, or the like.

In some implementations, the word “battery” or “batteries” will be used to describe certain elements of the embodiments described herein. It is noted that “battery” does not necessarily refer to only a single battery cell. Rather, any element described as a “battery” or illustrated in the Figures as a single battery in a circuit may equally be made up of any larger number of individual battery cells and/or other elements without departing from the spirit or scope of the disclosed systems and methods.

Reference may be made throughout the specification to a “12 volt” power systems or sources. It will be readily apparent to a person having ordinary skill in the art that the phrase “12 volt” in the context of automotive electrical systems is an approximate value referring to nominal 12 volt power systems. The actual voltage of a “12 volt” system in a vehicle may fluctuate as low as roughly 4-5 volts and as high as 16-17 volts depending on engine conditions and power usage by various vehicle systems. Such a power system may also be referred to as “low voltage” battery systems. Some vehicles may use two or more 12 volt batteries to provide higher voltages. Thus, it will be clear that the systems and methods described herein may be utilized with low voltage battery arrangements in at least the range of 4-34 volts without departing from the spirit or scope of the systems and methods disclosed herein.

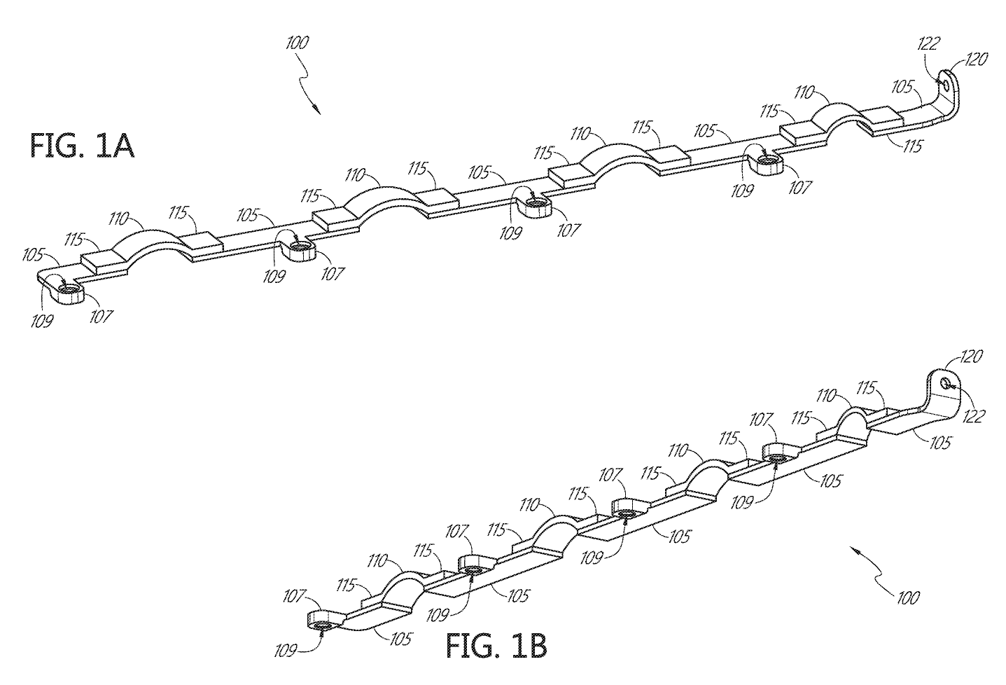

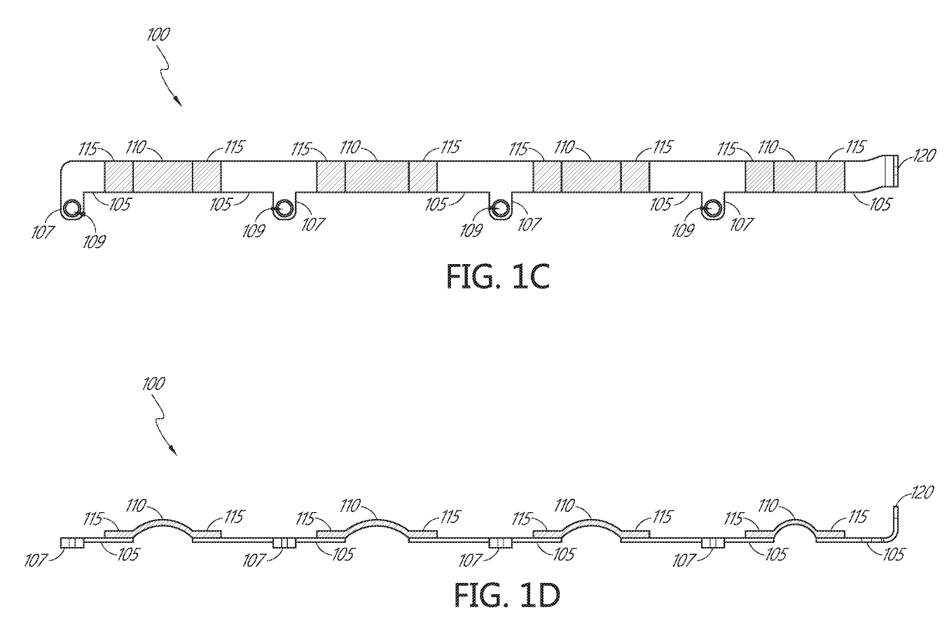

FIGS. 1A-1D depict a segmented flexible bus bar 100 in accordance with an exemplary embodiment. The bus bar 100 includes multiple rigid sections 105 and bendable or flexible sections 110 connected to the rigid sections 105 at connection points 115. Rigid sections 105 can include connection arms 107 configured to electrically connect the bus bar 100 to electrical components such as battery modules (not shown) by receiving a terminal post or other conductive structure at an aperture 109. An additional connection arm 120 and aperture 122 may be configured to facilitate an electrical connection between the electrical components connected at connection arms 107 and other circuitry. Flexible sections 110 may include an arched portion and a flat portion configured to conductively couple to a neighboring rigid section 105 at a connection point 115. The space above the rigid sections 105 may be able to accommodate additional electrical components, such as a printed circuit board (PCB) or other circuitry, e.g., for monitoring battery functionality.

In various embodiments, the bus bar 100 may be described in terms of longitudinal and transverse directions. For example, the bus bar 100 may extend along a longitudinal axis, with the rigid sections 105 and flexible sections 110 being coupled together in a generally straight line along the longitudinal direction. As pictured in FIGS. 1A-1D, the arched portions of the flexible sections 110 extend away from the longitudinal alignment of the bus bar 100 in a transverse direction normal to the longitudinal direction. In other embodiments (not shown), the flexible sections 110 may extend away from the longitudinal alignment of the bus bar 100 in a lateral direction normal to the longitudinal and transverse directions. In some aspects, the bus bars include holes through the bus bar in a transverse or lateral direction. In other aspects, as shown for example in FIGS. 1A-1D, the bus bars include connection arms 107 extending away from the longitudinal alignment of the bus bar 100 in the lateral direction which include apertures 109 which extend through the connection arms 107 in the transverse direction for receiving an electrical connection.

The rigid sections 105 of the bus bar 100 can be made of any suitable current carrying material. For example, the rigid sections 105 can be made of a metal, such as copper, aluminum, brass, alloys such as 6063 aluminum alloy, or other suitable conductive materials. The material used for the flexible sections 110 may be a metal selected to be relatively flexible, bendable, malleable, or otherwise suited to accommodate lengthwise expansion and/or contraction of the rigid sections 105. In some embodiments, the material selected for the flexible sections 110 may be the same as the material selected for the rigid sections 105. In various embodiments, some rigid sections 105 may comprise a different material from other rigid sections 105 of the same bus bar 100, and some flexible sections 110 may comprise a different material from the other flexible sections 110. The flexible sections 110 of the bus bar 100 can similarly be made of any suitable current carrying material. In some aspects, the rigid sections 105 are made a material that is more rigid in comparison to the material that comprises the flexible sections 110. In some aspects, rigid sections 105 are aluminum and the flexible sections 110 are copper.

Where the flexible sections 110 and the rigid sections 105 are made of the same material, the bus bar 100 may optionally be manufactured as a single piece of material, or the flexible sections 110 may be manufactured separately from the rigid sections 105 and secured to the rigid sections 105 at the connection points 115. Securing of the flexible sections 110 to the rigid sections 105 at connection points 115 may be achieved by any suitable connection method, for example, welding, soldering, brazing, bolting, riveting, or the like. Any metallic portion of the bus bar 100 may also be covered with a plating, such as a tin plating.

In various embodiments, the segmented flexible bus bar 100 described herein may be configured to prevent unwanted or inadvertent electrical connections or contacts (e.g., contact with conductive surfaces other than the connections at apertures 109, 122). In some implementations, some or all of the external surface of the bus bar, including the rigid sections 105, flexible sections 110, connection arms 107 and 120, may be covered with an electrically insulating material, such as polyester, polyurethane, polyester-epoxy, fusion bonded epoxy, acrylics, or other materials, which may be applied by powder coating, liquid application, or other suitable application method. The interior surfaces of the apertures 109, 122 and one or more nearby surfaces, such as a bottom side of a connection arm 107, 120, may be left uncovered by the electrically insulating coating so as to facilitate the electrical connections between the bus bar 100 and other electrical components.

In some embodiments, it may be impractical to apply the electrically insulating coating to the flexible sections 110, for example, because of the expected amount of flexing, material incompatibility with coating methods, or similar reasons. Accordingly, portions of the bus bar 100 may be covered with a separate insulating layer. For example, if the flexible sections 110 cannot be covered with an insulating coating applied to the remainder of the bus bar 100, a sleeve of an insulating material, such as a rubber, a plastic, a heat-shrink wrap or tubing, or the like may be applied around the flexible sections 110 after coating the remainder of the bus bar.

In some implementations, the flexible sections 110 of the bus bar 100 may be provided in an arched shape so as to provide additional clearance below the bus bar to avoid creating inadvertent electrical connections. The arched shape may also provide thermal stress release. In some aspects, the arched shape may reduce the effect of vibrations on the bus bar during vehicle driving. In some aspects, the flexible sections 110 are non-linear. In some aspects, the flexible sections 110 are shaped as springs or spring-like sections that are configured to move and/or expand to a greater extent than the rigid sections 105. Thus, in some implementations, the flexible sections 110 may be shaped to flex and/or bend to a greater extent than the rigid sections 105.

In some implementations, the flexible sections 110 of the bus bar 100 may have a different coefficient of thermal expansion than the rigid sections 105. Thermal expansion is the tendency of matter to change in volume in response to a change in temperature, through heat transfer. This property may be measured by a thermal linear expansion coefficient; defined as the fractional change in length of a particular material for each degree of temperature change. For example, the flexible sections 110 may have a coefficient of thermal expansion that is less than the coefficient of thermal expansion of the rigid sections 105, so as to limit the overall thermal expansion of the bus bar 100. In other embodiments, the flexible sections 110 may have a coefficient of thermal expansion that is greater than the coefficient of thermal expansion of the rigid sections 105, so as to increase the length and flexing capacity of the flexible sections 110 during high-temperature and/or high-current operations.

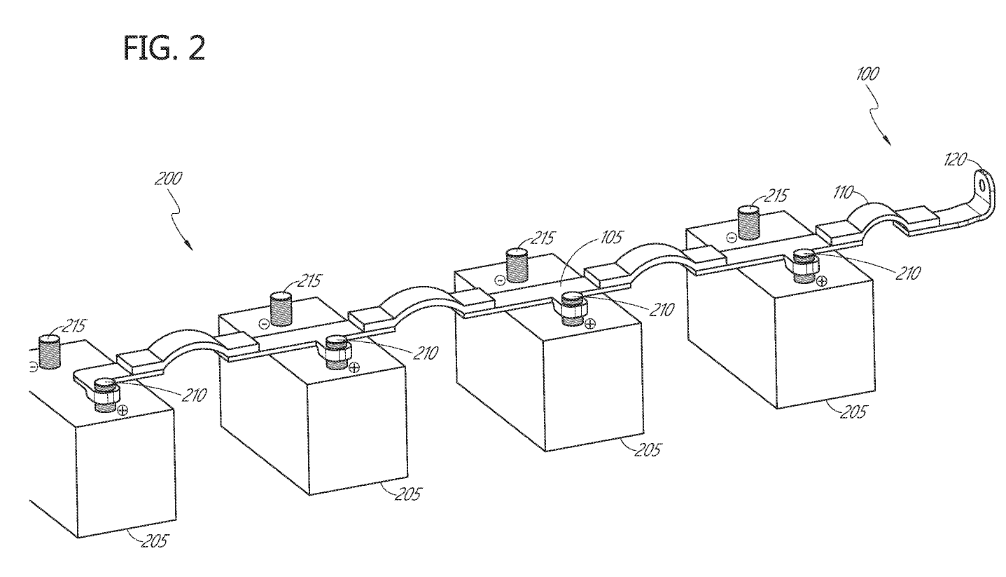

FIG. 2 depicts an example configuration of multiple electrical components connected by a segmented flexible bus bar. For example, the configuration 200 may include several battery modules 205 having positive terminal posts 210 and negative terminal posts 215. In the configuration depicted in FIG. 2, the positive terminal posts 210 are connected by the bus bar 100 such that the battery modules 205 may be connected in parallel. The negative terminal posts 215 may be connected to other circuitry or to a ground connection. In the embodiment shown, each rigid section 105 of the bus bar 100 has is configured to secure and electrically connect to a positive terminal post 210 of a battery module 205. The rigid sections 105 may be formed according to traditional methods for forming bus bars. In some aspects, the rigid sections 105 comprise bus bars. The battery modules 205 may be, for example, battery modules of a vehicle, such as low voltage or 12-volt battery modules. The external connection arm 120 may be configured to connect the bus bar 100 to current carrying circuitry configured to draw electrical power from the battery modules 205 to other systems of the vehicle.

The flexible sections 110 may be configured to accommodate relative movement, contraction, or expansion of the rigid sections 105. For example, in some embodiments, the battery modules 205 may not be rigidly secured, and may experience translational and/or rotational motion, causing the distances between the positive terminal posts 210 to change. In some embodiments, a standard operating current flowing from the battery modules 205 through the bus bar 100 may be of sufficient magnitude to cause significant thermal expansion, such that the rigid sections 105 of the bus bar 100 become longer. In such embodiments, the flexible sections 110 can bend to accommodate the change in length of the rigid sections 105 so as to avoid placing undue stress on the terminal posts 210 or otherwise interfering with the electrical connections.

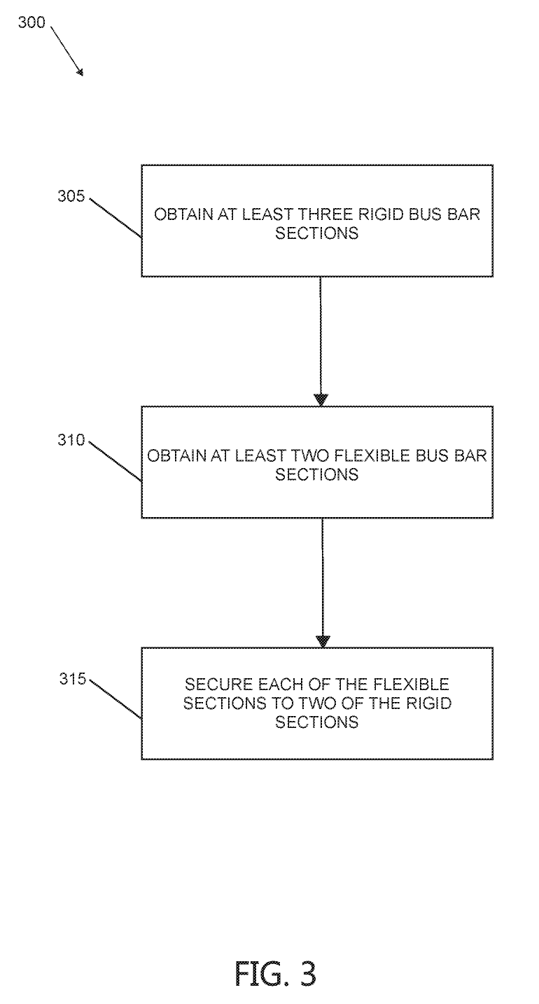

FIG. 3 is a flowchart depicting an example method 300 for manufacturing a segmented flexible bus bar. The method 300 begins at block 305, where at least three rigid metallic bus bar sections are obtained. The rigid bus bar sections can be similar to the rigid sections 105 described above with reference to FIGS. 1A-2. The rigid bus bar sections can include connection portions configured to receive and electrically connect with one or more electrical components, such as battery modules or the like. After the rigid metallic bus bar sections are obtained, the method 300 continues to block 310.

At block 310, at least two flexible metallic bus bar sections are obtained. The flexible metallic bus bar sections can be similar to the flexible sections 110 described above with reference to FIGS. 1A-2. The flexible metallic bus bar sections can include the same material as the rigid bus bar sections, or may be made of a different material, such as a more flexible metal. The flexible bus bar sections can further include an arched portion configured to bend and a flat portion configured to couple with the rigid metallic bus bar sections. After the flexible metallic bus bar sections are obtained, the method 300 continues to block 315.

At block 315, each of the at least two flexible metallic bus bar sections is conductively secured to two of the at least three rigid metallic bus bar sections. As described above with reference to FIGS. 1A-1D, the bus bar sections may be joined by any suitable method, such as welding, soldering, brazing, bolting, riveting, or the like. Preferably, the rigid sections and flexible sections are joined by a method that provides both electrical conductivity and a strong mechanical bond between the sections, so as to create a conductive electric bus bar that is structurally robust. After the flexible metallic bus bar sections are conductively secured to the rigid metallic bus bar sections, the method 300 can terminate. As described above, a plating and/or an electrically insulating coating can be applied to at least a portion of the exterior surface of the bus bar. The completed bus bar can then be connected to one or more electrical components. For example, in a vehicle, the rigid sections 105 of the bus bar can be connected to battery modules of the vehicle as described above with reference to FIG. 2. An external connection arm 120 as described with reference to FIGS. 1A-D can be connected to current-carrying circuitry configured to draw power from the battery modules to other systems of the vehicle.

The foregoing description and claims may refer to elements or features as being “connected” or “coupled” together. As used herein, unless expressly stated otherwise, “connected” means that one element/feature is directly or indirectly connected to another element/feature, and not necessarily mechanically. Likewise, unless expressly stated otherwise, “coupled” means that one element/feature is directly or indirectly coupled to another element/feature, and not necessarily mechanically. Thus, although the various schematics shown in the Figures depict example arrangements of elements and components, additional intervening elements, devices, features, or components may be present in an actual embodiment (assuming that the functionality of the depicted circuits is not adversely affected).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the implementations are not limited to the precise configuration and components illustrated above. Various modifications, changes, and variations may be made in the arrangement, operation, and details of the methods and apparatus described above without departing from the scope of the implementations.

Although this invention has been described in terms of certain embodiments, other embodiments that are apparent to those of ordinary skill in the art, including embodiments that do not provide all of the features and advantages set forth herein, are also within the scope of this invention. Moreover, the various embodiments described above can be combined to provide further embodiments. In addition, certain features shown in the context of one embodiment can be incorporated into other embodiments as well.

1. A flexible bus bar comprising:
two electrically conductive bus bars coupled together with an electrically conductive joint, the conductive bus bars each configured to be coupled to at least one electrical connection, the conductive joint configured to allow the two bus bars to move relative to one another,
wherein each of the bus bars comprises a connection arm extending away from a longitudinal alignment of the bus bar in a lateral direction, and
wherein each connection arm comprises an aperture configured for receiving the electrical connection.

2. The flexible bus bar of claim 1, wherein the electrical connection comprises a terminal post of a battery module.

3. The flexible bus bar of claim 1, wherein at least a portion of the exterior surface of the bus bars are covered by an electrically insulating material.

4. The flexible bus bar of claim 3, wherein the electrically insulating material comprises an insulating powder coating.

5. The flexible bus bar of claim 4, wherein at least a portion of the exterior surface of the conductive joint is covered by an electrically insulating material.

6. The flexible bus bar of claim 5, wherein the electrically insulating material covering the conductive joint comprises a rubber wrap.

7. The flexible bus bar of claim 1, wherein the two electrically conductive bus bars and the electrically conductive joint extend in one linear direction.

8. The flexible bus bar of claim 1, further comprising an additional conductive joint coupling one of the two bus bars to an additional bus bar, the additional bus bar configured to be coupled to at least one electrical connection, and the additional conductive joint configured to allow the three bus bars to move with respect to one another.

9. A flexible bus bar comprising:
two electrically conductive bus bars coupled together with an electrically conductive joint, the two conductive bus bars each configured to be coupled to at least one electrical connection, the conductive joint having a thermal linear expansion coefficient that is different than the thermal linear expansion coefficient of the bus bars.

10. The flexible bus bar of claim 8, wherein the conductive joint has a thermal linear expansion coefficient that is less than the thermal linear expansion coefficient of the bus bars.

11. The flexible bus bar of claim 8, wherein the conductive joint has a thermal linear expansion coefficient that is greater than the thermal linear expansion coefficient of the bus bars.

12. The flexible bus bar of claim 8, further comprising an additional conductive joint coupling one of the two bus bars to an additional bus bar, the additional bus bar configured to be coupled to at least one electrical connection, the additional conductive joint having the same thermal linear expansion coefficient as the conductive joint and the additional bus bar having the same thermal linear expansion coefficient as the two bus bars.

13. A flexible bus bar comprising:
two electrically conductive bus bars coupled together with an electrically conductive joint, the two conductive bus bars each configured to be coupled to at least one electrical connection, the conductive joint configured to be more flexible when compared to the bus bars,
wherein each of the bus bars comprises a connection arm extending away from a longitudinal alignment of the bus bar in a lateral direction, and
wherein each connection arm comprises an aperture configured for receiving the electrical connection.

14. The flexible bus bar of claim 13, wherein the electrical connection comprises a terminal post of a battery module.

15. The flexible bus bar of claim 13, wherein at least a portion of the exterior surface of the bus bars are covered by an electrically insulating material.

16. The flexible bus bar of claim 15, wherein the electrically insulating material comprises an insulating powder coating.

17. The flexible bus bar of claim 16, wherein at least a portion of the exterior surface of the conductive joint is covered by an electrically insulating material.

18. The flexible bus bar of claim 17, wherein the electrically insulating material covering the conductive joint comprises a rubber wrap.

19. The flexible bus bar of claim 13, wherein two electrically conductive bus bars and the electrically conductive joint extend in one linear direction.

20. The flexible bus bar of claim 13, further comprising an additional conductive joint coupling one of the two bus bars to an additional bus bar, the additional bus bar configured to be coupled to at least one electrical connection, and the additional conductive joint configured to be more flexible when compared to the bus bars.
